(19) United States
(12) Patent Application Publication
(10) Pub. No.: US 2009/0061792 A1
(43) Pub. Date: Mar. 5, 2009

(54) Trail beacon system to prevent becoming lost in unfamiliar terrain

(76) Inventor: Gary L. Oliver, Suffolk, VA (US)

Correspondence Address: WILLIAMS G. SYKES, 3669 SEAGULL BLUFF DRIVE, VIRGINIA BEACH, VA, 23455, US

(21) Appl. No.: 11/897,802

(22) Filed: Sep. 4, 2007

(51) Int. Cl. H04B 1/38

(52) U.S. Cl. 455/90.1

(57) ABSTRACT

A trail marking system consisting of a plurality of identical beacon units, each capable of communicating with another unit. The beacon units contain audible and visible signaling devices that may be used independently or in combination. The units are designed to be deployed along a path of ingress into unfamiliar terrain. When a user wishes to retrace his or her steps, the closest beacon unit is activated and audible, visible, or both, depending on the mode selected. The closest beacon unit transmits an RF signal that propagates to the next beacon unit. Upon receipt of the RF signal, the second beacon unit activates in the selected mode. As the user returns to each of the previously deployed beacon units, they are collected for reuse. The beacon units of the present invention are weatherproof, have a long battery life, and are designed to be virtually invisible to game animals, for example, deer.

### FIELD OF THE INVENTION

The invention pertains to devices to prevent a person from becoming lost, and more particularly, to a system of trail marker devices that optionally emit sound or light and are communicative with one another to guide a person when in unfamiliar terrain.

### BACKGROUND OF THE INVENTION

The problem of becoming lost or disoriented when in unfamiliar terrain is ancient. In the familiar fairy story of Hansel and Gretel, when the children are led into the forest where they are to be abandoned, Hansel gathers white pebbles and leaves a trail which the children follow to return to their home. When taken into the woods a second time, Hansel has only breadcrumbs to leave as trail markers. Unfortunately, various animals eat the breadcrumbs, and the children are unable to find their way home.

It is well known to leave trail markers consisting of colored flags, sticks oriented in a certain manner, piles of stones in a specific shape or orientation, and many other such devices. While these may be useful in the daytime, they become virtually useless in the darkness of night. In addition, with such trail markers of the prior art, the direction to the next trail marker may not be obvious.

However, there has heretofore been nothing available to effectively guide a person after the fall of darkness. While hanging lanterns or traditional electrically powered beacons has been done, lanterns provide a fire risk, and both lanterns and traditional electrically powered beacons have relatively short effective operating periods. In addition, there is no communication between one lantern or beacon and the next.

The trail beacon of the present invention overcomes these well known limitations and provides a truly useful system for use by hunters, hikers, woodsmen, or other persons entering unfamiliar terrain.

### DISCUSSION OF THE RELATED ART

U.S. Pat. No. 6,147,602 for LUGGAGE LOCATOR SYSTEM, issued Nov. 14, 2000 to Sheldon Bender, teaches an object locator system having a transmitter unit, which upon actuating a pushbutton, sends an RF signal to a receiver unit that may be attached to an object for detecting the RF signal and illuminating a light element. The luggage or other object to which the receiver is attached, may then readily be located.

United States Published Patent Application No. 2006/0077058 for LUGGAGE LOCATOR, published Apr. 13, 2006, upon application by Del Asher, provides another apparatus, wherein a receiver attached to an object, such as luggage, provides a visible signal upon actuation by a remote transmitter.

United States Published Patent Application No. 2004/0252030 for OBJECT LOCATING SYSTEM INCLUDING ADDRESSABLE REMOTE TAGS, published Dec. 16, 2004, upon application by Bradley G. Trimble et al., provides a another object location system wherein a single transmitter unit can selectively address plural remote tags.

United States Published Patent Application No. 2003/0067397 for OBJECT LOCATING SYSTEM EMPLOYING RF SIGNAL, published Apr. 10, 2003, upon application by Bradley G. Trimble et al., teaches another object location system, wherein plural, remote tags may be selectively actuated by the remote transmitter.

U.S. Pat. No. 7,064,662 for MASTER SIGNAL TRANSMITTER WITH ALLIED SERVANT RECEIVER TO RECEIVE A DIRECTED SIGNAL FROM THE TRANSMITTER, issued Jun. 20, 2006 to Christopher M. Goggin, provides a transmitter capable of activating one or more remote devices and awakening them from a sleep mode to actuate visible and/or audible signals.

U.S. Pat. No. 6,674,364 for OBJECT FINDER, issued Jan. 6, 2004 to Paul Robert Holbrook et al., discloses another object locating system, wherein a remote transmitter is used to selectively actuate one of a plurality of remote receivers located on objects to be found.

U.S. Pat. No. 6,466,134 for WIRELESS COMMUNICATION DEVICES, WIRELESS COMMUNICATION SYSTEMS, COMMUNICATION METHODS, METHODS OF FORMING RADIO FREQUENCY IDENTIFICATION DEVICES, METHODS OF TESTING WIRELESS COMMUNICATION OPERATIONS, RADIO FREQUENCY IDENTIFICATION DEVICES, AND METHODS OF FORMING RADIO FREQUENCY IDENTIFICATION DEVICES, issued Oct. 15, 2002 to Mark T. Van Horn et al., teaches apparatus and method of forming, operating, and testing RFID devices.

U.S. Pat. No. 6,133,832 ARTICLE LOCATION SYSTEM, issued Oct. 17, 2002 to Jeffrey S. Winder et al., provides an article location system that includes a number of identical receiver tags attachable to articles, and a transmitter assembly unit that transmits a predetermined, coded radio signal to selectively activate each of the receiver tags.

None of the patents and published patent applications, taken singly, or in any combination are seen to teach or suggest the novel trail beacon system of the present invention.

### SUMMARY OF THE INVENTION

In accordance with the present invention, there is provided a system consisting of a plurality of identical beacon units, each capable of communicating with other units. The beacon units each contain audible and visible signaling devices that may be used independently or in combination. The units are designed to be left along a path of ingress into unfamiliar terrain. When a user wishes to retrace his or her steps out of the unfamiliar terrain, the closest beacon unit is activated and audible, visible, or both visible and audible, depending on the mode selected. The closest beacon unit transmits an RF signal that propagates to nearby beacon units. Upon receipt of the RF signal, the second beacon unit then activates in the selected mode. The beacons allow the user to retrace his or her steps through the unfamiliar terrain. As the user returns to each of the previously deployed beacon units, they are collected for reuse. The beacon units of the present invention are weatherproof, have a long battery life, and are designed to be virtually invisible to game animals, for example, deer.

It is, therefore, an object of the invention to provide a system of beacon units, each providing selectable audible and visible operating modes.

It is another object of the invention to provide a system of beacon units that are communicative with one another.

It is an additional object of the invention to provide a system of beacon units that are weatherproof for outdoor use.

It is a further object of the invention to provide a system of beacon units that have long battery life for extended deployment.

It is a still further object of the invention to provide a system of beacon units that are unobtrusive to game animals.

It is yet another object of the invention to provide a system of beacon units, transmitting on a standard frequency to attract attention of a search party when a user of the beacon units becomes lost or disabled.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a simplified, schematic block diagram of a system of beacon units in accordance with the invention;

FIG. 2 is a simplified schematic block diagram of a single one of the beacon units of FIG. 1; and

FIG. 3 is a detailed, electrical schematic diagram of the beacon unit of FIG. 2.

### DETAILED DESCRIPTION OF THE PREFERRED EMBODIMENT

The present invention provides a system of beacon units communicative with one another. The beacon units may be left along a path of ingress when traveling into unfamiliar terrain. Each beacon unit is identical to every other beacon unit, and includes a flashing mechanism as well as an audible tone generating mechanism.

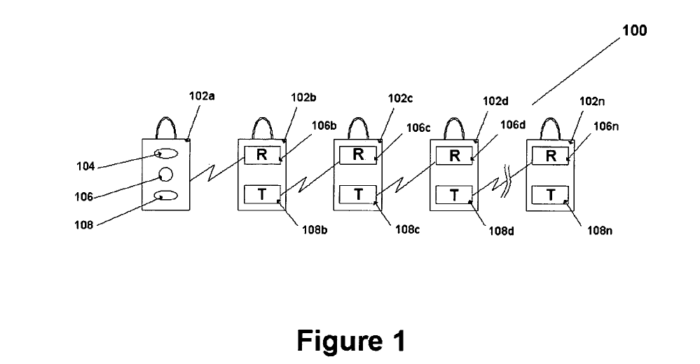

Referring first to FIG. 1, there is shown a simplified schematic block diagram of a system of beacon units in accordance with the present invention, generally at reference number 100. Beacon units 102a, 102b, 102c, 102d, . . . 102n each contain three switches. Switch 104 selects a flashing mode of operation; switch 108 selects an audible tone mode of operation; and switch 106 selects a combination of both flashing and audible tone modes.

Each beacon unit 102a . . . 102n contains both a receiver unit 106a . . . 106n, and a transmitter unit 108a . . . 108n, respectively. Receiver units 106a . . . 106n are configured to receive an RF signal from transmitter unit 108a . . . 108n, of another one of beacon units 102a . . . 102n.

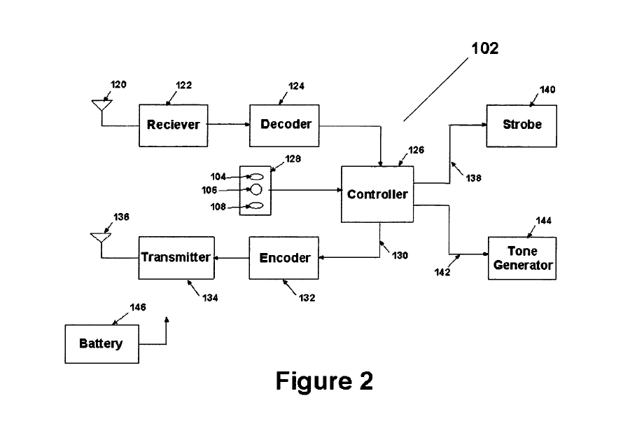

Referring now also to FIG. 2, there is shown a simplified, schematic block diagram of one of the single beacon units 102a . . . 102n, designated as reference number 102.

A receive antenna 120 is connected to a receiver 122 that, in turn, has an output connected to the input of a decoder 124. The output of decoder 124 is connected to controller 126.

A switch unit 128 containing at least switches 104, 106, and 108, is also connected to controller 126.

An output 130 of controller 126 is connected to an input of encoder 132. Encoder 132 has an output connected to an input of transmitter 134. The output of transmitter 134 is connected to a transmit antenna 136.

Another output 138 of controller 126 is connected to strobe unit 140.

Yet another output 142 of controller 126 is connected to tone generator 144.

Power is provided to all internal circuitry of beacon unit 102 by battery 146. Controller 126 typically includes a power management function, not specifically identified, to maximize the life of battery 146 by providing a sleep mode wherein drain on battery 146 is minimized.

Both receiver 122 and transmitter 134 are typically tunable and a user may manually select one of several pre-determined frequencies of operation. While no tuning mechanism is specifically identified, such mechanisms are believed to be well known to those of skill in the art.

While two discrete antennas (receive antenna 120 and transmit antenna 136) have been shown for purposes of disclosure, it will be recognized that the functions of these two antennas may be combined into a single antenna using appropriate circuitry. Such circuitry is believed to be well known to those of skill in the art and is not further described herein.

In the embodiment chosen for purposes of disclosure, receiver 122 is a type RXM-418-LR long-range receiver manufactured by Linx Technologies, Inc. of Merlin, Oreg. USA. Transmitter 134 is a type TXM-418-LR long-range unit also from Linx Technologies, Inc. Both receiver 122 and transmitter 134 operate at approximately 418 MHz. Other suitable receiver and transmitter units are known to those of skill in the radio control arts and my be substituted for the Linx Technologies, Inc. units chosen for purposes of disclosure.

The functions of decoder 124, encoder 132, and controller 126 are performed by a micro-controller using appropriate microcode as is well known to those of skill in the art. A PIC16F505 micro-controller from Microchip Technology, Inc. of Chandler, Ariz. USA. has been found suitable for the application.

Tone generator 140 is a piezoelectric buzzer Type BRP2207P-30 manufactured by CML Innovative and available from Digi-Key Corporation of Thief River Falls, Minn. USA as Catalog No. CMD3750-MD.

It will be recognized that other micro-controllers and tone generators can be used with beacon unit 120. Such micro-controllers and tone generators are believed to be well known to those skilled in the art. Consequently, a detailed description of such components is not provided herein.

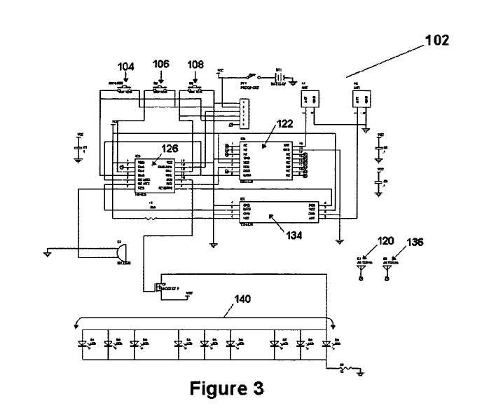

Referring now also to FIG. 3, there is shown a detailed, electrical schematic diagram of the beacon unit 102 of FIG. 2.

Other circuitry and/or components for implementing the functions of the aforementioned components of beacon unit 120 is believed to be well known to those skilled in the art. Consequently, a detailed description of such circuitry is not provided herein. It will also be recognized by those skilled in the circuit design arts that many alternative circuit designs may be utilized to provide the functions necessary to implement beacon unit 120. The invention is, therefore, not limited to any particular circuitry. Rather, the invention covers any and all implementations of the required functions.

In operation, a user actuates trail beacon system 100 by selecting strobe, tone, or both strobe and tone modes using an appropriate one of switches 104, 106, or 108 at an arbitrary one of the beacon units 102a . . . 102n. The arbitrarily selected beacon unit 102a . . . 102n then begins flashing, emitting a tone, or both flashing and emitting a tone. In addition, an RF signal at a preselected, fixed frequency is generated and transmitted. The RF signal contains information that causes other beacon units 102a . . . 102n receiving the RF signal to operate in a mode identical to the beacon unit 102a . . . 102n from which the signal originates. The remote beacon unit 102a . . . 102n cycles a predetermined number of times. In the embodiment of the trail beacon system chosen for purposes of disclosure, the beacon units 102a . . . 102n flash, emit a tone, or both flash an emit a tone three times. It will be recognized that the number of cycles is arbitrary and other numbers of cycles may be chosen to meet a particular operating circumstance or environment.

Other ones of beacon units 102a . . . 102n within radio range receive the transmitted RF signal. Prior to receipt of the transmitted RF signal, other beacon units 102a . . . 102n are assumed to be in a power saving, sleep mode. However, the received RF signal awakens these units, which then mimic the mode of the original transmitting beacon unit 102a . . . 102n. In typical operation, the beacon units 102a . . . 102n have be deployed along a trail in a linear arrangement so that only a single one of beacon units 102a . . . 102n will be within range of the beacon unit 102a . . . 102n activated by the user.

Upon activation of the remote beacon unit 102a . . . 102n, the user may walk theretowards, thereby retracing his or her steps back along the ingress route. If necessary, the beacon unit 102a . . . 102n in the possession of the user may be reactivated thereby activating the next beacon unit 102a . . . 102n to help guide the user.

Upon reaching the next unit along the trail, the user repeats the process, thereby activating the next beacon unit 102a . . . 102n. The process is repeated until the user has emerged from the marked terrain.

Because each beacon unit 102a . . . 102n acts as both a receiver and transmitter, the units are completely interchangeable. In other words, there are no designated master or slave units. Any beacon unit 102a . . . 120n may perform either function.

As long as a beacon unit 102a . . . 102n is within radio range of another one thereof, a virtually unlimited number of beacon units 102a . . . 102n may be cascaded, thereby effectively marking a long trail.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A trail marking system, comprising a plurality of beacon units, each comprising:
a) a receiver adapted to receive an RF signal from a transmitter in another of said plurality of beacon units;
b) a decoder operatively connected to said receiver for decoding information from said RF signal;
c) a controller operatively connected to said decoder;
d) at least one selected from the group: a light-generating apparatus, and a sound generating apparatus operatively connected to said controller;
e) an encoder operatively connected to said controller; and
f) a transmitter operatively connected to said encoder.

2. The trail marking system as recited in claim 1, wherein each of said beacon units is identical to one another.

3. The trail marking system as recited in claim 1, wherein said light-generating apparatus and said sound-generating apparatus may be selectively actuated by said controller.

4. The trail marking system as recited in claim 3, wherein said light-generating apparatus and said sound-generating apparatus may be selectively actuated in combination.

5. The trail marking system as recited in claim 1, wherein said RF signal comprises a predetermined frequency.

6. The trail marking system as recited in claim 5, wherein said predetermined frequency comprises a plurality of selectable, predetermined frequencies.

7. The trail marking system as recited in claim 5, wherein said predetermined frequency is approximately 418 MHz.

8. The trail marking system as recited in claim 1, further comprising:
g) a receiving antenna, and a transmitting antenna.

9. The trail marking system as recited in claim 8, wherein said receiving antenna and said transmitting antenna comprise a single antenna.

10. A method of providing trail marking, the steps comprising:
a) providing a trail marking system comprising a plurality of beacon units, each comprising, a receiver adapted to receive an RF signal from a transmitter in another of said plurality of beacon units; a decoder operatively connected to said receiver; a controller operatively connected to said decoder; at least one of a light-generating, and a sound-generating apparatus each operatively connected to said controller; an encoder operatively connected to said controller; and a transmitter operatively connected to said encoder;
b) deploying ones of said plurality of beacon units, along a trail of ingress into unfamiliar terrain;
c) actuating a selected one of said plurality of beacon units and a selected mode of operation;
d) transmitting from said selected one of said plurality of beacon units, an RF signal indicative of said selected mode of operation;
e) receiving at another one of said plurality of beacon units, said RF signal; and
f) activating said another one of said plurality of beacon units in a mode of operation based upon said RF signal.

11. The method of providing trail marking as recited in claim 10, wherein each of said plurality of beacon units has an effective transmission distance, and said deploying step (b) comprises deploying ones of said plurality of beacon units spaced apart from one another at a distance no more than said effective transmission distance.

12. The method of providing trail marking as recited in claim 10, wherein said activating step (f) comprises the sub-steps:
i) awakening said another one of said beacon units from a sleep mode; and
ii) operating said another one of said beacon units in said mode of operation a predetermined number of cycles.

13. The method of providing trail marking as recited in claim 12, wherein said operating sub-step (ii) comprises operating said another one of said beacon units three times.
